(19) United States
(12) Patent Application Publication
(10) Pub. No.: US 2014/0074270 A1
(43) Pub. Date: Mar. 13, 2014

(54) Audio Read-Out System, Audio Read-Out Device, and Audio Read-Out Method

(71) Applicant: Koumei Kubota, Osaka (JP)

(72) Inventor: Koumei Kubota, Osaka (JP)

(73) Assignee: PANASONIC CORPORATION, Kadoma-shi, Osaka (JP)

(21) Appl. No.: 14/006,967

(22) PCT Filed: Dec. 21, 2011
(86) PCT No.: PCT/JP2011/007181

§ 371 Date: Sep. 24, 2013

(30) Foreign Application Priority Data
Mar. 29, 2011 (JP) 2011-073249

(51) Int. Cl. H04H 20/86; G06F 17/30

(52) U.S. Cl. CPC H04H 20/86; G06F 17/3074
USPC 700/94

(57) ABSTRACT

An audio read-out system comprises a client and a server, the client including a remote-control input to accept a remote control; a first communicator to transmit a request per the remote control to the server, a process controller; an audio generator; an audio output; a client-main-memory; and a process controller to cause the audio generator to repeatedly generate an audio signal indicating a process per the remote control, to cause associated processing on content in the client-main-memory during the process, and to cause the audio generator to generate an audio signal corresponding to playback progress of the content, and the server including a second communicator to receive the client request and to return response data; a storage; a server-main-memory; and a content manager to manage content in the storage and content-information in the server-main-memory, and per the received request, to establish the managed content and content-information as the response data.

### TECHNICAL FIELD

The present invention relates to an audio read-out system, an audio read-out device, and an audio read-out method that are applied to a client receiving digital broadcast signals and to a server operating in association with the client, so as to enable audio notification of the status of the client and the server.

### BACKGROUND ART

Conventionally, a digital broadcast receiver that receives and plays back digital broadcast signals functions to give audio notification of the status of the digital broadcast receiver. Such a function is useful for viewer/listeners with weak eyesight and viewer/listeners with impaired vision.

Patent Literature 1 discloses technology of a device that outputs a program reservation code as audio when it has received the program reservation code for a program reservation inputted by a viewer/listener's remote control operation.

Further, in recent years, digital broadcast receivers provide various functions such as recording and playing back television programs, and establishing Internet connection in association with remote devices.

### CITATION LIST

### Patent Literature

[PTL 1] Japanese Laid-Open Patent Publication No. 2006-287645

### SUMMARY OF THE INVENTION

### Problems to be Solved by the Invention

However, according to Patent Literature 1, since a television receiver performs audio read-out upon acceptance of a remote control operation by a viewer/listener, it has, for example, been impossible to notify the viewer/listener via audio of the progress as to how far the process has subsequently proceeded.

Therefore, an object of the present invention is to provide an audio read-out system, an audio read-out device, and an audio read-out method for enabling a viewer/listener, when a remote control operation by the viewer/listener is received and while the process corresponding to the remote control operation is being continued, to recognize via audio detailed information on the process, including the progress and the end status of the process.

### Solution to the Problems

To attain the above objects, an audio read-out system according to the present invention includes a client configured to receive and play back a digital broadcast signal; and a server operating in association with the client. The client includes: a remote-control input stage configured to receive a remote control operation by a viewer/listener; a first communication stage configured to transmit to the server a request corresponding to the remote control operation by the viewer/listener and to receive response data corresponding to the request; a process controller controlling a process corresponding to the remote control operation by the viewer/listener, received by the remote-control input stage, and a process corresponding to the response data received by the first communication stage; an audio generator generating an audio signal relating to the processes controlled by the process controller; and an audio output stage configured to play back the audio signal generated by the audio generator. The server includes: a second communication stage configured to receive from the client the request corresponding to the remote control operation by the viewer/listener and to transmit to the client the response data corresponding to the request; a storage having stored therein content to be played back by the client; a main memory having stored therein information on the content stored in the storage; a content managing stage configured to manage the content stored in the storage and the information on the content stored in the main memory, and based on the request received by the second communication stage, to determine the managed content and information on the content as the response data.

Further, the process controller preferably causes the audio generator to repeatedly generate an audio signal indicating the process corresponding to the remote control operation by the viewer/listener accepted by the remote control input stage, while the process is being continued.

Still more preferably, the client further includes a main memory having stored therein content and information on the content that are received by the first communication stage as the response data, and the process controller causes execution of a process on the content stored in the main memory, based on the remote control operation by the viewer/listener received by the remote-control input stage.

Further preferably, the process controller causes the audio generator to generate an audio signal representing speed for playing back the content executed by the process controller.

Further preferably, the process controller causes the audio generator to generate an audio signal corresponding to progress of playback of the content executed by the process controller.

Further preferably, when a plurality of the content items are to be executed by the process controller and to be successively played back, the process controller causes the audio generator to generate an audio signal indicating a title of one of the content items, based on the information on the content items at a time when the playback of the content items switches from one to another.

Further preferably, the server establishes as the response data information indicating status of the server, based on the request received by the second communication stage; and in the client, the process controller causes the audio generator to generate an audio signal corresponding to the information indicating the status of the server, received as the response data by the first communication stage.

Further, the server and the client may be made up of any of an HDMI (High-Definition Multimedia Interface), a DLNA (Digital Living Network Alliance), and a radio network.

Further, the server may be embedded in the client.

To attain the above objects, an audio read-out device according to the present invention includes a remote control input stage configured to accept a remote control operation by a viewer/listener; a communication stage configured to transmit, to a remote device having stored content therein, a request corresponding to the remote control operation by the viewer/listener, and to receive response data corresponding to the request; a process controller controlling a process corresponding to the remote control operation by the viewer/listener, received by the remote-control input stage, and a process corresponding to the response data received by the communication stage; an audio generator generating an audio signal relating to the process controlled by the process controller; and an audio output stage configured to play back the audio signal generated by the audio generator, wherein the process controller causes the audio generator to repeatedly generate an audio signal indicating the process corresponding to the remote control operation by the viewer/listener, accepted by the remote control input stage, while the process is being continued.

Further, to attain the above objects, the processes executed by the components of the audio read-out system and the audio read-out device of the present invention can be considered as an audio read-out method of providing a series of processing steps. The method is provided in a form of a program causing a computer to execute the series of processing steps. The program may be introduced into a computer by being stored in a computer-readable recording medium.

### Advantageous Effects of the Invention

As described above, with the audio read-out system, the audio read-out device, and the audio read-out method according to the present invention, when a remote control operation by a viewer/listener is received and while the process corresponding to the remote control operation is being continued, the viewer/listener can via audio recognize detailed information on the process, including the progress and the end status of the process.

### BRIEF DESCRIPTION OF THE DRAWINGS

FIG. 1 is a diagram showing an audio read-out system according to the present invention.

FIG. 2 is a conceptual diagram showing a process by an audio read-out system according to a first embodiment of the present invention.

FIG. 3 is a functional block diagram illustrating a digital broadcast receiver according to the present invention.

FIG. 4 is a functional block diagram illustrating a remote device according to the present invention.

FIG. 5 is a flow chart showing steps of generating an audio signal in a fast-forwarding process executed by a process controller of the digital broadcast receiver according to the present invention.

FIG. 6 is a conceptual diagram illustrating a process by an audio read-out system according to a second embodiment of the present invention.

FIG. 7 is a flow chart showing a switching process executed by the audio read-out system according to the second embodiment of the present invention.

### MODE FOR CARRYING OUT THE INVENTION

Hereinafter, embodiments of the present invention will be described with reference to the drawings.

### First Embodiment

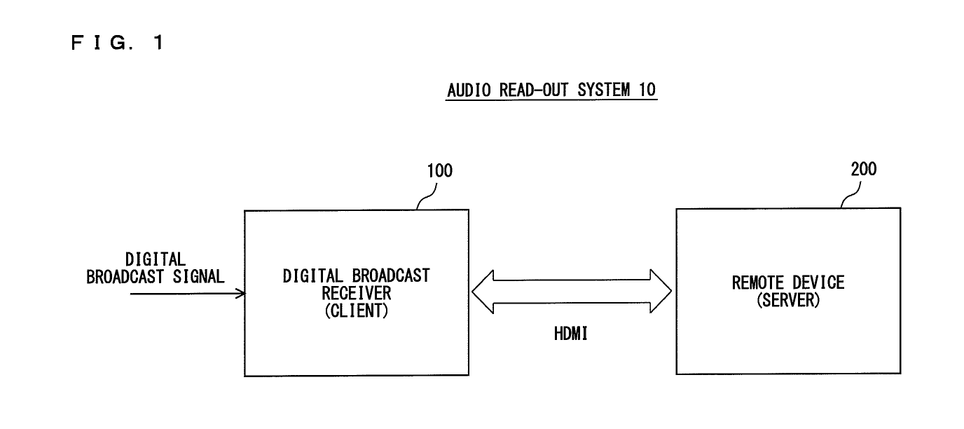

FIG. 1 is a diagram showing an audio read-out system 10 according to the present invention. In FIG. 1, the audio read-out system 10 is made up of a digital broadcast receiver (client) 100 and a remote device (server) 200.

The digital broadcast receiver 100 is a so-called digital television that receives and plays back digital broadcast signals transmitted from a broadcasting station.

The remote device 200 is a device operating in association with the digital broadcast receiver 100, and, for example, has stored therein digital broadcast content received by the digital broadcast receiver 100. In addition, the remote device 200 may be configured to read content of a recording medium such as a Blu-ray Disc or the like, or store the content into a hard disk embedded therein.

The digital broadcast receiver 100 and the remote device 200 perform communication with each other through HDMI (High-Definition Multimedia Interface). Alternatively, they may be formed through DLNA (Digital Living Network Alliance) and a radio network.

With the above-described configuration, a viewer/listener can view and listen to content stored in the remote device 200 on the digital broadcast receiver 100. Further, in the audio read-out system 10 according to the present invention, the digital broadcast receiver 100 includes an audio read-out function of audio-outputting, to notify the viewer/listener of, information indicating the status of the remote device 200 and the status of the playback of content.

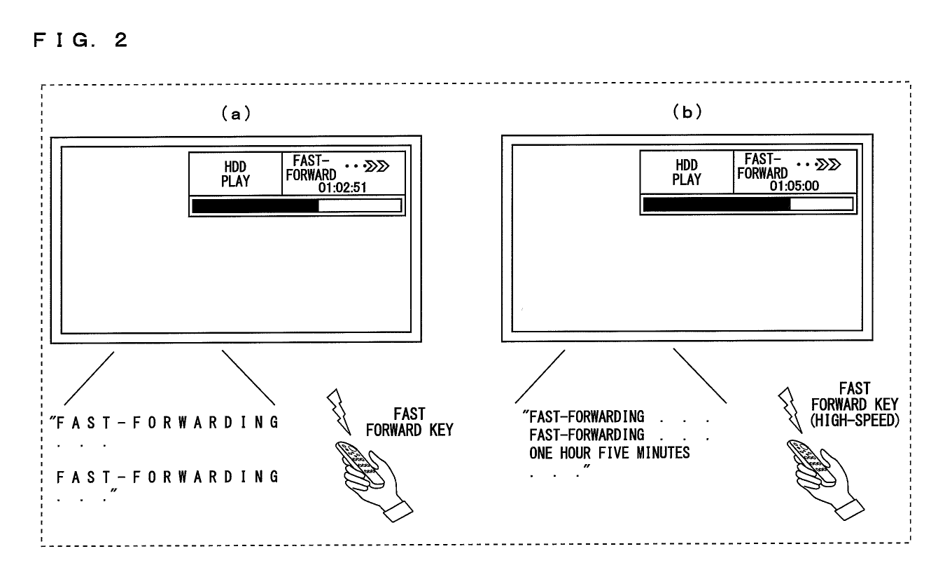

Hereinafter, the audio read-out function of the audio read-out system 10 according to the present invention will be described in detail. FIG. 2 is a conceptual diagram showing a process by the audio read-out system according to the first embodiment of the present invention. In FIG. 2, a viewer/listener operates a remote control of the digital broadcast receiver 100 to fast-forward content stored in a hard disk of the remote device 200. From the digital broadcast receiver 100, an audio output indicating the fast-forwarding process is provided to notify the viewer/listener of the execution of the fast-forwarding process.

Specifically, in (a) of FIG. 2, when the viewer/listener presses a fast-forward key of the remote control of the digital broadcast receiver 100, fast-forwarding of content stored in the hard disk of the remote device 200 is executed, and audio representing “fast-forwarding” is outputted from a loudspeaker of the digital broadcast receiver 100. Further, in this embodiment, not only when the viewer/listener has pressed the fast-forward key of the remote control, but also while the fast-forwarding process is being continued, the audio representing “fast-forwarding” is repeatedly outputted from the loudspeaker of the digital broadcast receiver 100.

Further, in (b) of FIG. 2, when the viewer/listener presses a high-speed fast-forward key of the remote control, high-speed fast-forwarding of content stored in the hard disk of the remote device 200 is executed, and depending on the speed of the fast-forwarding process, audio representing “fast-forwarding” is outputted from the loudspeaker of the digital broadcast receiver 100. In a similar manner to that in (a) of FIG. 2, while the high-speed fast-forwarding process is being continued, the audio representing “fast-forwarding” is repeatedly outputted from the loudspeaker of the digital broadcast receiver 100.

In this embodiment, the read-out speed is expressed differently between “fast-forwarding” and “fast-forwarding” so that the viewer/listener can recognize the speed of the fast-forwarding process. Alternatively, audio representing “fast-forwarding level 1,” “fast-forwarding level 3,” “low-speed fast-forwarding,” and “high-speed fast-forwarding,” for example, may be outputted to enable the viewer/listener to recognize the speed of the fast-forwarding process.

Further, in (b) of FIG. 2, “one hour five minutes,” an audio representing time, is outputted to notify the viewer/listener of the progress of the fast-forwarding process. Still further, when a plurality of content items are continuously played back, the title of a content item may be read-out when the playback of the content items is switched from one to another.

Further, although the fast-forwarding process is described as an example in this embodiment, a rewinding process may be carried out. Alternatively, any other process may be carried out as long as such processes are executed by the digital broadcast receiver 100 in association with the remote device 200.

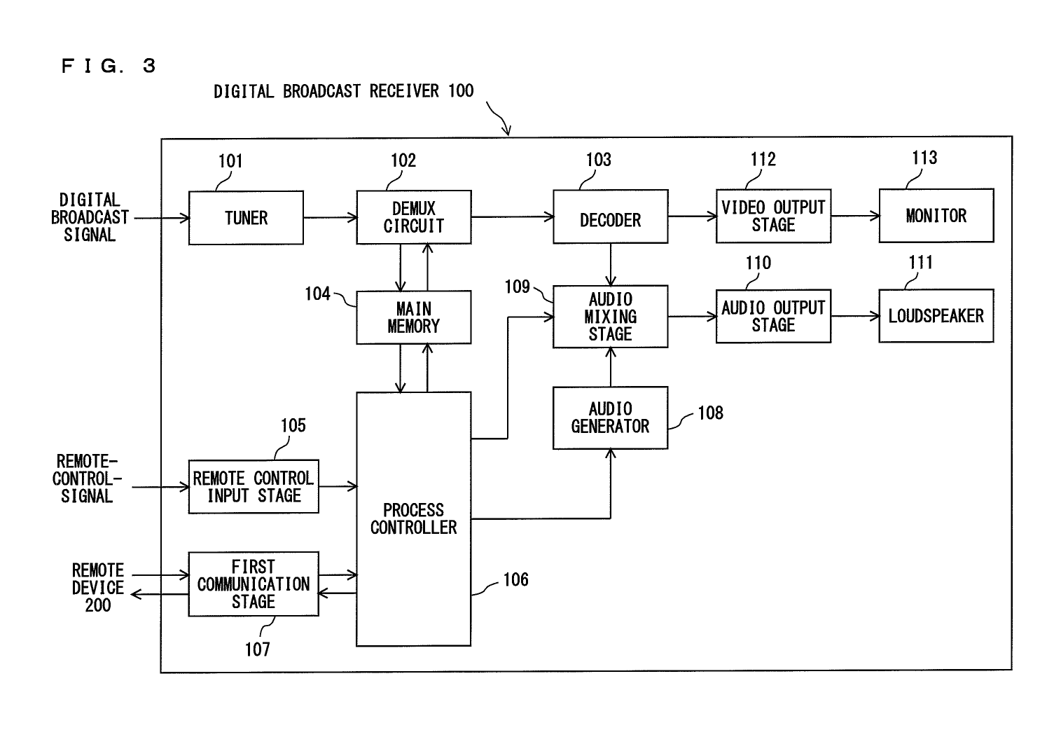

Next, the digital broadcast receiver 100 of the audio read-out system 10 according to the present invention will be described in detail. FIG. 3 is a functional block diagram showing the digital broadcast receiver 100 according to the present invention. In FIG. 3, the digital broadcast receiver 100 includes a tuner 101, a DEMUX circuit 102, a decoder 103, a main memory 104, a remote control input stage 105, a process controller 106, a first communication stage 107, an audio generator 108, an audio mixing stage 109, an audio output stage 110, a loudspeaker 111, a video output stage 112, and a monitor 113.

The tuner 101 performs processes such as decoding on a digital broadcast signal received by an antenna (not shown) from the broadcasting station, and transmits the decoded signal to the DEMUX circuit 102.

The DEMUX circuit 102 divides the signal from the tuner 101 into MPEG (Moving Picture Experts Group) data and subsidiary program information. The DEMUX circuit 102 transmits the MPEG data to the decoder 103, and the program-accompanying information to the main memory 104.

The decoder 103 decodes the MPEG data from the DEMUX circuit 102 to transmit a resultant video signal to the video output stage 112. The video output stage 112 outputs the video signal from the decoder 103 to the monitor 113 to display video. The decoder 103 also decodes the MPEG data from the DEMUX circuit 102 to transmit a resultant audio signal to the audio mixing stage 109.

The main memory 104 has stored therein program-accompanying information from the DEMUX circuit 102, and response data from the remote device 200 received through the first communication stage 107. The response data includes content stored in the remote device 200 to be described later, information on the content including the content title, and so on. The content is transmitted to the DEMUX circuit 102 as playback data.

The remote control input stage 105 receives a remote control signal generated by an operation of the remote control by the viewer/listener, and notifies the process controller 106 of the reception.

The process controller 106 controls a process corresponding to the viewer's remote control operation accepted by the remote control input stage 105. Specifically, when the remote control input stage 105 accepts a fast-forwarding operation, the process controller 106 controls transmission of a request indicating the fast-forwarding operation to the remote device 200 through the first communication stage 107. The process controller 106 then receives content, which is response data from the remote device 200 corresponding to the request, through the first communication stage 107, and stores the content in the main memory 104.

The process controller 106 controls playback of response data which is received from the remote device 200 and stored in the main memory 104, while managing the viewer/listener's remote control operation which is accepted by the remote control input stage 105, the status of communication with the remote device 200 which status is transmitted and received through the first communication stage 107, and the response data, and then controls the audio generator 108 to generate an audio signal depending on the playback control. When the remote control input stage 105 has accepted the fast-forwarding operation, the process controller 106 controls the fast-forwarding process of content stored in the main memory 104, and transmits a request to the audio generator 108 for generation of an audio signal corresponding to the fast-forwarding process.

More specifically, when the fast-forwarding process is being executed, the process controller 106 transmits to the audio generator 108 a request to generate an audio signal indicating the audio representing “fast-forwarding”. Further, the process controller 106 may transmit to the audio generator 108 a request to generate an audio signal indicating the progress of the fast-forwarding process, and an audio signal indicating the speed of the fast-forwarding process, while controlling the status of the fast-forwarding process.

Further, it may be arranged such that the process controller 106 transmits, during the period when the fast-forwarding process is being continued, to the audio generator 108 a request to repeatedly generate an audio signal indicating the fast-forwarding process, whereas the process controller 106 transmits, upon completion of the fast-forwarding process, to the audio generator a request to generate an audio signal indicating audio representing “complete fast-forwarding.” During the period when the fast-forwarding process is being continued, the repetition of the audio signal indicating the audio representing “fast-forwarding” may be conducted continuously or at predetermined time intervals (e.g., every 5 minutes). Further, the repetition may be determined depending on the speed of the fast-forwarding process.

It should be noted that the audio signal which is requested of the audio generator 108 by the process controller 106 may be a signal indicating the above-described audio representing “fast-forwarding,” or may be a signal indicating a (bing bong) sound of “pon,” “pipipi,” or the like.

Further, when an audio signal is provided by the decoder 103, the process controller 106 controls the audio mixing stage 109, to be described later, to mix the audio signal from the decoder 103 and the audio signal generated by the audio generator 108.

The first communication stage 107 transmits to the remote device 200 a request corresponding to the viewer/listener's remote control operation, and receives response data corresponding to the request. In the above-described example, the first communication stage 107 transmits a request indicating the fast-forwarding operation to the remote device 200, and from the remote device 200 receives content that is response data corresponding to the request. Further, the first communication stage 107 may receive information on the content including the title of the content, and information indicating the status of the remote device 200.

The audio generator 108 generates an audio signal relating to the process controlled by the process controller 106. Specifically, the audio generator 108 generates, based on the request from the process controller 106, an audio signal indicating the audio representing “fast-forwarding” relating to the fast-forwarding process, for example. Further, the audio generator 108 may generate an audio signal indicating the speed of the fast-forwarding process.

Further, the audio generator 108 may generate, based on the request from the process controller 106, an audio signal indicating the progress of the fast-forwarding process and an audio signal indicating the speed of the fast-forwarding process. Specifically, the audio signal may be “fast-forwarding,” “fast-forwarding level 1,” “high-speed fast-forwarding,” or the like.

Further, when there are a plurality of content items, and they are played back continuously, the audio generator 108 may generate an audio signal indicating a title of a content item based on the information on the content when playback of the content items switches from one to another.

The audio mixing stage 109 mixes the audio signal from the decoder 103 and the audio signal generated by the audio generator 108, based on control by the process controller 106.

The audio output stage 110 outputs the audio signal received from the audio mixing stage 109 through the loudspeaker 111 to thereby play back the audio signal.

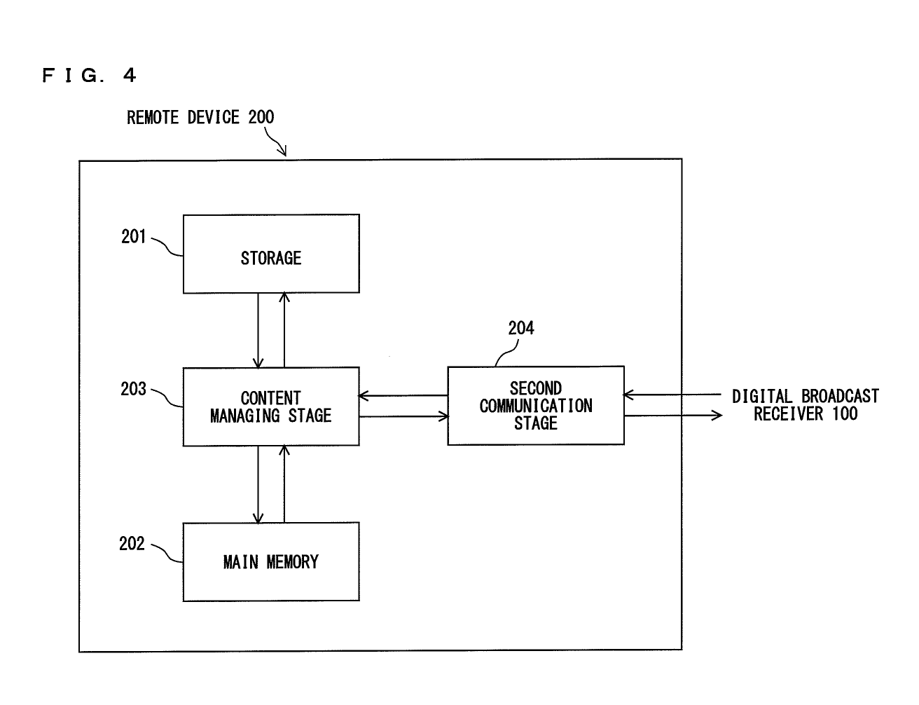

Next, the remote device 200 of the audio read-out system 10 according to the present invention will be described in detail. FIG. 4 is a functional block diagram showing the remote device 200 according to the present invention. In FIG. 4, the remote device 200 includes a storage 201, a main memory 202, a content managing stage 203, and a second communication stage 204.

The storage 201 has stored therein content items to be played back by the digital broadcast receiver 100. The content items may be digital broadcast content items received by the digital broadcast receiver 100, or may be content items read from a recording medium such as a Blu-ray Disc.

The storage 201 has stored therein normal playback content items for normal playback and fast-forward content items which are different from the normal playback content items. A fast-forward content item represents a content item during predetermined time intervals (e.g., data in a time period of 10 to 11 seconds, data in 20 to 21 seconds, and data in 30 to 31 seconds from the start position, etc.).

The main memory 202 has stored therein information on content items stored in the storage 201. The information on a content item represents information indicating a title and a time for playback of the content.

The content managing stage 203 manages the content items stored in the storage 201 and the information on the content items stored in the main memory 202. The content managing stage 203 determines, based on the request transmitted from digital broadcast receiver 100 received through the second communication stage 204, the managed content items and information on the content items as response data.

Specifically, upon reception of a request indicating a fast-forwarding operation from the digital broadcast receiver 100, the content managing stage 203 determines, based on the request, a fast-forward content item stored in the storage 201 as the response data. The response data is then transmitted to the digital broadcast receiver 100 through the second communication stage 204. The content managing stage 203 determines the information on the fast-forward content as response data, and, for example, it may transmit to the digital broadcast receiver 100 the speed of the fast-forwarding process, the progress of the fast-forwarding process, the title of the content item, and the like, as the response data, through the second communication stage 204. Further, the fast-forward content items are not necessarily stored in the storage 201 in advance, but may be generated as response data on a per-request basis with each request from the digital broadcast receiver 100. Further, the method of generating the response data may be provided by the digital broadcast receiver 100.

The second communication stage 204 receives from the digital broadcast receiver 100 a request corresponding to the viewer/listener's remote control operation, and transmits to the digital broadcast receiver 100 the response data determined by the content managing stage 203 in response to the request.

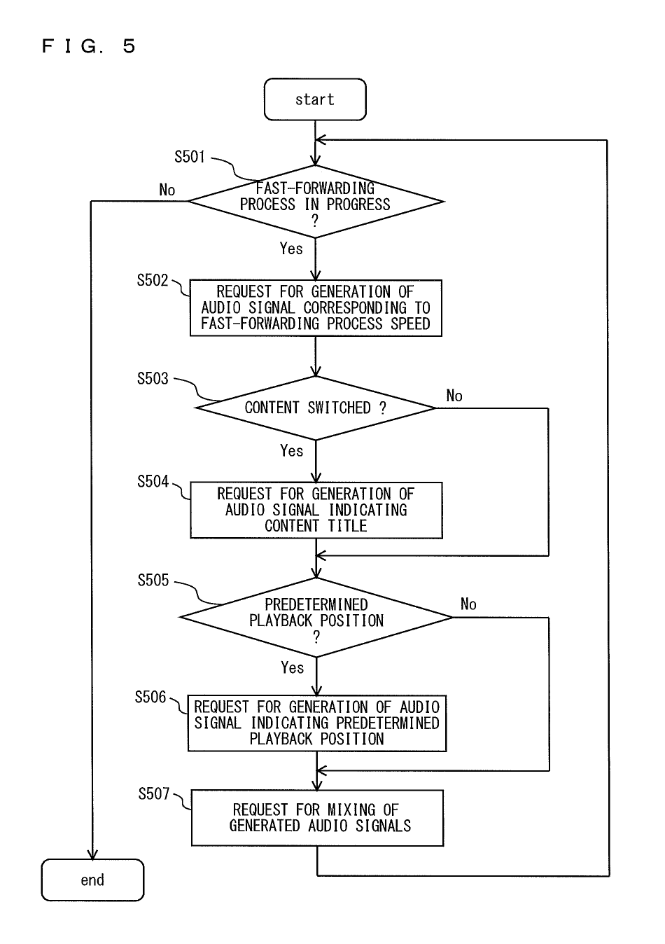

The audio read-out method executed by the digital broadcast receiver 100 during the fast-forwarding process may be described in detail. FIG. 5 is a flow chart showing steps for generating an audio signal during the fast-forwarding process executed by the process controller 106 of the digital broadcast receiver 100 according to the present invention.

In step S501, the process controller 106 determines whether the fast-forwarding process is being continued or not. If the fast-forwarding process is being continued (Yes in step S501), the processing proceeds to step S502, whereas if the fast-forwarding process is not being continued (No in step S501), the processing ends.

In step S502, the process controller 106 transmits to the audio generator 108 a request to generate an audio signal corresponding to the fast-forwarding process speed. Specifically, the process controller 106 detects the speed of the fast-forwarding process based on at least one of the viewer/listener's remote control operations accepted by the remote control input stage 105, the status of communication with the remote device 200 transmitted and received through the first communication stage 107, and the status of the response data received from the remote device 200, stored in the main memory 104. The process controller 106 then transmits to the audio generator 108 a request to generate an audio signal that enables the viewer/listener to recognize the speed of the fast-forwarding process.

In step S503, when a plurality of content items are continuously played back, the process controller 106 determines whether content switching from one content item to another occurs. Specifically, the process controller 106 may detect content switching based on the information on content items received from the remote device 200. When content switching occurs (Yes in step S503), the processing proceeds to step S504, whereas when content switching does not occur (No in step S503), the processing proceeds to step S505.

In step S504, the process controller 106 transmits to the audio generator 108 a request to generate an audio signal indicating the title of a content item to be played back after switching.

In step S505, the process controller 106 determines whether a playback position for a content item is a predetermined playback position. The predetermined playback position may be, for example, a playback position determined based on fixed time units such as a position at every five minutes or ten minutes from the start of the content playback, or a playback position determined based on a fixed proportion of the total playback time, such as a position at every 5% or 10% of the total playback time. The predetermined playback position may be determined in advance, or may be determined freely by the viewer.

When the playback position for a content item is a predetermined playback position (Yes in step S505), the processing proceeds to step S506, whereas when the playback position of the content is not a predetermined playback position (No in step S505), the processing proceeds to step S507.

In step S506, the process controller 106 transmits to the audio generator 108 a request to generate an audio signal indicating the predetermined playback position. For example, the process controller 106 transmits a request to generate an audio signal indicating elapsed playback time or a rate of elapsed playback time such that the viewer/listener can recognize the progress of the fast-forwarding process.

In step S507, the process controller 106 transmits to the audio mixing stage 109 a request to mix the audio signal generated by the audio generator 108 based on the above-described request from the process controller 106 with an audio signal from the decoder 103. The processing returns to step S501, and while the fast-forwarding process is being continued, audio signals are repeatedly generated. The process of repetitive audio signal generation may be executed continuously, or a predetermined wait time after step S504 may be determined, and the process executed at predetermined time intervals.

As described above, with the audio read-out system 10 according to the present invention, not only when the viewer/listener's remote control operation has been received, but also while the process corresponding to the remote control operation is being continued, the viewer/listener can be notified via audio of detailed information on the process, including the progress and the end status of the process.

It should be noted that the present embodiment describes a case of executing the fast-forwarding process, but is not limited to this. For example, in a case of executing a rewinding process, an audio signal indicating audio representing “rewinding” will be generated, which obviously exhibits an effect similar to that in the case of executing the above-described fast-forwarding process.

### Second Embodiment

The first embodiment of the present invention describes audio read-out system relating to a so-called running process such as fast-forwarding process and rewinding process. In the present embodiment, description will be given of an audio read-out system regarding a process switching performed between a digital broadcast receiver and a remote device that operates in association with the digital broadcast receiver. Since the audio read-out system, the digital broadcast receiver, and the remote device according to the present embodiment are identical to the audio read-out system 10 shown in FIG. 1, the digital broadcast receiver 100 shown in FIG. 3, and the remote device 200 shown in FIG. 4, respectively, detailed description on the individual components will not be given.

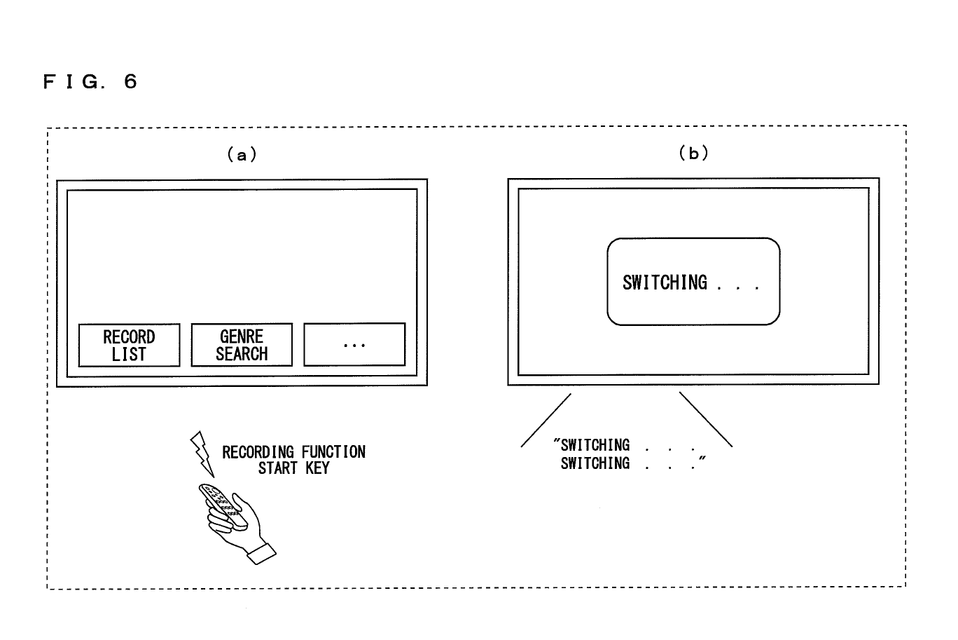

FIG. 6 is a conceptual diagram showing a process by the audio read-out system according to the second embodiment of the present invention. In FIG. 6, the viewer/listener operates the remote control of the digital broadcast receiver 100 to start a function of digital broadcast recording on the remote device 200. Audio indicating a process of function-switching to a function of recording on the remote device 200 is outputted from the digital broadcast receiver 100 to notify the viewer/listener of execution of the switching process.

Specifically, in (a) of FIG. 6, when a viewer/listener presses a recording function start key, the function of digital broadcast recording is started on the remote device 200, and in (b) of FIG. 2, audio representing “switching” is outputted from the loudspeaker of the digital broadcast receiver 100. Further, not only when the viewer/listener presses the recording function start key on the remote control, but also while the switching process is being continued, the audio representing “switching” is outputted repeatedly from the loudspeaker of the digital broadcast receiver 100.

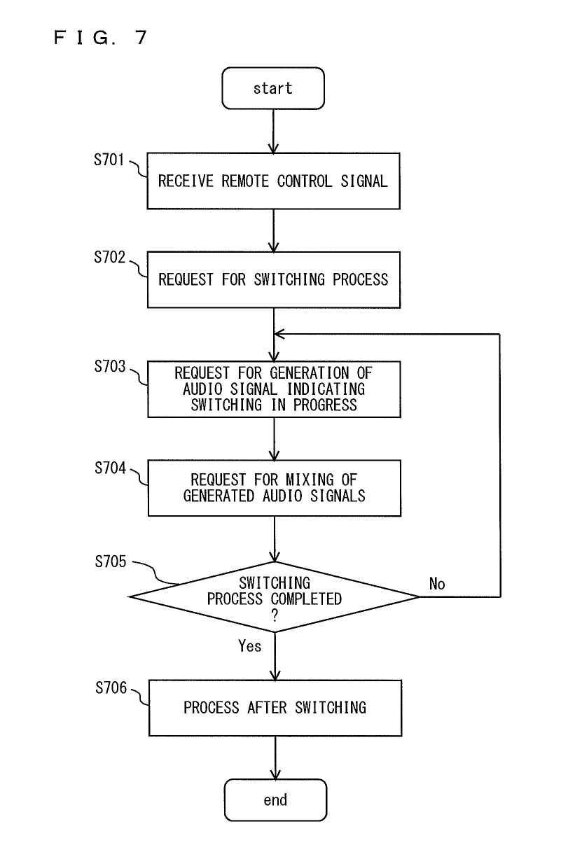

Next, the process executed by the audio read-out system of the second embodiment of the present invention will be described in detail. FIG. 7 is a flow chart showing the switching process executed by the audio read-out system according to the second embodiment of the present invention.

In step S701, the remote control input stage 105 of the digital broadcast receiver 100 receives a remote control signal by the viewer/listener's remote control operation. In this embodiment, the remote control input stage 105 receives a remote control signal for causing the remote device 200 to start the function of digital broadcast recording.

In step S702, the process controller 106 of the digital broadcast receiver 100 controls the process corresponding to the viewer/listener's remote control operation accepted by the remote control input stage 105, and transmits to the remote device 200 through the first communication stage 107 a request to start the function of digital broadcast recording.

In step S703, the process controller 106 of the digital broadcast receiver 100 transmits to the audio generator 108 a request to generate an audio signal indicating that a process of function-switching to the function of digital broadcast recording on the remote device 200 is in progress.

In step S704, the process controller 106 of the digital broadcast receiver 100 transmits to the audio mixing stage 109 a request to mix the audio signal generated by the audio generator 108 based on the above-described request from the process controller 106 with an audio signal from the decoder 103.

In step S705, the process controller 106 of the digital broadcast receiver 100 determines whether the process of function-switching to the function of digital broadcast recording on the remote device 200 has completed. Specifically, the process controller 106 may receive a completion notice indicating completion of the switching process from the remote device 200 through the first communication stage 107.

When the switching process has completed (Yes in step S705), the processing proceeds to step S706, whereas when the switching process has not completed (No in step S705), the processing returns to step S703.

After returning to step S703 (No in step S705), the processing in step S703 and step S704 is repeated, and an audio indicating that the process of function-switching to the function of digital broadcast recording on the remote device 200 is read out repeatedly. Further, the repetition of the audio output indicating that the switching is in progress may be performed continuously, or may be performed at predetermined time intervals (e.g., at every 5 seconds). If the audio output is repeated at predetermined time intervals, a predetermined wait time after step S704 may be established.

In step S706, the digital broadcast receiver 100 and the remote device 200 execute a process after the function-switching to the function of digital broadcast recording on the remote device 200. Specifically, a window to access the function of digital broadcast recording on the remote device 200 is displayed on the monitor 113 of digital broadcast receiver 100 to receive selection of a program to be recorded by the viewer/listener's remote control operation, or to check the available space of the storage 201 for saving the program.

Further, when it is determined in step S705 that the switching process has completed (Yes in step S705), in step S706, the process controller 106 of the digital broadcast receiver 100 may transmit to the audio generator 108 a request to generate an audio signal indicating that the process of function-switching to the function of recording the digital broadcast on the remote device 200 has completed.

As described above, with the audio read-out system 10 according to the present invention, not only when the viewer/listener's remote control operation has been received, but also while the process corresponding to the remote control operation is being continued, the viewer/listener can be notified via audio of detailed information on the process including the progress and the end status of the process.

It should be noted that the present embodiment describes the process of function-switching to the function of digital broadcast recording on the remote device 200 as an example, but is not limited this. If the present embodiment is applied to a process leading to duration of wait by processing at the remote device 200, an effect similar to that described above can obviously be obtained. For example, the process includes, for example, booting up, scanning, formatting, and resetting of the remote device 200.

Further, in the first and second embodiments of the present invention, the audio read-out system 10 is made up of the digital broadcast receiver 100 and remote device 200 that communicate with each other using HDMI, but is not limited to this. For example, the function corresponding to the remote device 200 may be embedded in the digital broadcast receiver 100.

### INDUSTRIAL APPLICABILITY

The present invention is useful for an audio read-out system or the like which enables a viewer/listener to recognize via audio the process in execution according to the viewer/listener's remote control operation.

### DESCRIPTION OF THE REFERENCE CHARACTERS

10 audio read-out system

100 digital broadcast receiver (client)

101 tuner

102 DEMUX circuit

103 decoder

104, 202 main memory

105 remote control input stage

106 process controller

107, 204 communication stage

108 audio generator

109 audio mixing stage

110 audio output stage

111 loudspeaker

112 video output stage

113 monitor

200 remote device (server)

201 storage

203 content managing stage

1. An audio read-out system, comprising:
a client configured to receive and play back a digital broadcast signal; and
a server operating in association with the client; the client including:
a remote-control input stage configured to accept a remote control operation by a viewer/listener;
a first communication stage configured to transmit to the server a request corresponding to the remote control operation by the viewer/listener and to receive response data corresponding to the request;
a process controller controlling a process corresponding to the remote control operation by the viewer/listener accepted by the remote control input stage, and a process corresponding to the response data received by the first communication stage;
an audio generator generating an audio signal relating to the processes to be controlled by the process controller; and
an audio output stage configured to play back the audio signal generated by the audio generator;
a main memory having stored therein content and information on the content that are received by the first communication stage as the response data;
the process controller:
causing the audio generator to repeatedly generate an audio signal indicating the process corresponding to the remote control operation by the viewer/listener accepted by the remote control input stage, while the process is being continued;
causing execution of processing on the content stored in the main memory of the client based on the remote control operation by the viewer/listener accepted by the remote control input stage; and
causing the audio generator to generate an audio signal corresponding to progress of playback of the content executed by the process controller;
the server including:
a second communication stage configured to receive from the client the request corresponding to the remote control operation by the viewer/listener, and to transmit to the client the response data corresponding to the request;
a storage having stored therein content to be played back by the client;
a main memory having stored therein information on the content stored in the storage; and
a content managing stage configured to manage the content stored in the storage and the information on the content stored in the main memory of the server, and based on the request received by the second communication stage, to establish the managed content and information on the content as the response data.

2-3. (canceled)

4. The audio read-out system according to claim 1, wherein the process controller causes the audio generator to generate an audio signal representing speed for playing back the content executed by the process controller.

5. (canceled)

6. The audio read-out system according to claim 1, wherein, when a plurality of content items are to be executed by the process controller and to be successively played back, the process controller causes the audio generator to generate an audio signal indicating a title of one of the content items based on the information on the content items at a time when reproduction of the content items switches from one to another.

7. The audio read-out system according to claim 1, wherein
the server establishes information indicating status of the server as the response data, based on the request received by the second communication stage; and
in the client, the process controller causes the audio generator to generate an audio signal corresponding to the information indicating the status of the server that is received as the response data by the first communication stage.

8. The audio read-out system according to claim 1, wherein the server and the client are configured into a system through HDMI (High-Definition Multimedia Interface), DLNA (Digital Living Network Alliance), or a wireless network.

9. The audio read-out system according to claim 1, wherein the server is embedded in the client.

10. An audio read-out device comprising:
a remote control input stage configured to accept a remote control operation by a viewer/listener;
a communication stage configured to transmit to a remote device having content stored therein a request corresponding to the remote control operation by the viewer/listener, and to receive response data corresponding to the request;
a process controller controlling a process corresponding to the remote control operation by the viewer/listener accepted by the remote control input stage, and a process corresponding to the response data received by the communication stage;
an audio generator generating an audio signal relating to the processes to be controlled by the process controller; and
an audio output stage configured to play back the audio signal generated by the audio generator; wherein
the process controller causes the audio generator to repeatedly generate an audio signal indicating the process corresponding to the remote control operation by the viewer/listener accepted by the remote control input stage, while the process is being continued, and causes the audio generator to generate an audio signal corresponding to progress of playback of the content executed by the process controller when a running-system-related process is performed.

11. An audio read-out method comprising:
receiving a remote control operation by a viewer/listener;
transmitting a request corresponding to the remote control operation by the viewer/listener to the server;
receiving content and information on the content from the server as response data;
controlling a process corresponding the remote control operation by the viewer/listener and a process corresponding to the response data;
repeatedly generating, while the processes are being continued, an audio signal relating to the process corresponding to the remote control operation by the viewer/listener, and the process corresponding to the response data;
generating an audio signal corresponding to progress of reproduction of the content when a running-related process is being performed; and
reproducing the generated audio signal.

12. The audio read-out device according to claim 10, wherein, when a plurality of content items are to be executed by the process controller and to be successively played back, the process controller causes the audio generator to generate an audio signal indicating a title of one of the content items based on the information on the content items at a time when playback of the content items switches from one to another.

13. The audio read-out device according to claim 10, wherein, in a case of the process leading to duration of wait by processing at the remote device, the process controller causes the audio generator to generate an audio signal corresponding to information indicating a state of the remote device, the state being received by the communication stage as the response data.

14. The audio read-out method according to claim 11, further comprising, when a plurality of the content items are to be executed by the process controller and to be successively played back, generating an audio signal indicating a title of one of the content items based on the information on the content items at a time when playback of the content items switches from one to another.

15. The audio read-out method according to claim 11, further comprising, in a case of a process causing a state of continuously waiting for the remote device, generating an audio signal corresponding to information indicating a state of the remote device, the state being received as the response data.
